(19) United States
(12) Patent Application Publication
(10) Pub. No.: US 2010/0060709 A1
(43) Pub. Date: Mar. 11, 2010

(54) LINE LIGHT SOURCE, LINE PRINTER HEAD, AND IMAGE FORMING APPARATUS INCLUDING THE LINE PRINTER HEAD

(75) Inventors: Young-chul KO, Yongin-si (KR); Woo-Kyu KIM, Suwon-si (KR); Shang-Hyeun PARK, Yongin-si (KR); Jong-Chul CHOI, Suwon-si (KR)

Correspondence Address: DLA PIPER LLP US, P. O. BOX 2758, RESTON, VA, 20195, US

(73) Assignee: SAMSUNG ELECTRONICS CO., LTD., SUWON-SI (KR)

(21) Appl. No.: 12/477,938

(22) Filed: Jun. 4, 2009

(30) Foreign Application Priority Data
Sep. 9, 2008 (KR) 10-2008-0088945

(51) Int. Cl. B41J 2/435; G01N 23/04

(52) U.S. Cl. 347/224; 250/581

(57) ABSTRACT

Disclosed are a line light source, a line printer head, and an image forming apparatus. The line light source includes a light waveguide unit which guides light emitted from a light emitting layer which is disposed between a bottom electrode and top electrodes, wherein the light waveguide unit is disposed on the top electrodes. Light is emitted through the surface area of light emitting areas defined by overlapping areas of the bottom electrode and the top electrodes. The light waveguide includes a plurality of openings, the sizes of which may be different than the surface area of the light emitting areas. The light emitting amount can be adjusted by adjusting the light emitting surface areas without reducing printing resolution of the image forming apparatus by employing the disclosed line light source as the line printer head.

### CROSS-REFERENCE TO RELATED PATENT APPLICATION

This application claims the benefit of Korean Patent Application No. 10-2008-0088945, filed on Sep. 9, 2008, in the Korean Intellectual Property Office, the disclosure of which is incorporated herein in its entirety by reference.

### TECHNICAL FIELD

The present disclosure relates to a line light source, a line printer head, and an image forming apparatus including the line printer head.

### BACKGROUND OF RELATED ART

In an electro-photographic image forming apparatus, an electrostatic latent image is formed on a surface of an image carrier unit, the electrostatic latent image is developed using a developing agent such as toner, the toner image is transferred onto a printing medium, and the transferred developing image is fused onto the printing medium, thereby forming an image.

A laser printer, which is a non-limiting example of the image forming apparatus, and which is currently in wide usage, typically includes a polygon-mirror to scan laser beams that are emitted from a laser diode in order to form an image pattern on a photosensitive drum, which is a non-limiting example of an image carrier unit. However, a light scanning unit employing a polygon mirror has limitations in obtaining a high speed printing and realizing a compact size image forming apparatus. Also, since the laser beam may be incident on the photosensitive drum at a large angle, the laser beam could be reflected off the photosensitive drum surface during the scanning of the laser beam in the main scanning direction.

To alleviate the above problems associated with scanning of a laser beam, a line printer head (LPH) that forms an electrostatic latent image by simultaneously irradiating light along the entire line, e.g., one line at a time, on the surface of the photosensitive drum has been suggested. When a line printer head including an LED is used, a compact image forming apparatus may be realized in contrast to the case of an image forming apparatus using a laser scanning method. However, when the line printer head includes an LED, it may be difficult to arrange the light emitting chips as a plurality of modules in the main scanning direction. Further, the respective brightness of each light emitting chip may not be uniform. Thus, remedial measures of preventing the possible formation of spots, e.g., by adjusting brightness with the driving circuits, may become necessary. Such remedial measures may however increase the manufacturing costs.

Recently, attempts have been made to use electroluminescent devices in line printer heads. An electroluminescent device may be an organic electroluminescent (OLE) device or an inorganic electroluminescent (IEL) device. However, these OEL or IEL devices have lower light emitting power than LEDs, and may thus be difficult to use in forming electrostatic latent images on a photosensitive drum.

### SUMMARY OF THE DISCLOSURE

According to an aspect of the present disclosure, there is provided a line light source including: a bottom electrode; a light emitting layer formed above the bottom electrode; a plurality of transparent top electrodes arranged above the light emitting layer; and a light waveguide unit formed above the plurality of transparent top electrodes. The light waveguide unit may have a plurality of openings. The light waveguide unit being configured to guide light emitted from the light emitting layer to be emitted from the line light source through one or more of the plurality of openings. The plurality of transparent top electrodes may each define a light emitting area.

The plurality of openings may be arranged to each correspond to the light emitting area of a respective corresponding one of the plurality of transparent top electrodes.

The plurality of the openings may be arranged along a single line.

The plurality of the openings may be formed on the top surface or on a lateral surface of the light waveguide unit.

Each of the plurality of openings may have a size smaller than the surface area of the light emitting area of the corresponding one of the plurality of transparent top electrodes.

The light emitting area may extend along a sub-scanning direction.

The line light source may further comprise a micro lens disposed at each of the openings.

The light waveguide unit may comprise a plurality of transparent bodies; and a reflection layer formed on one or more of a top surface and lateral surfaces of each of the plurality of transparent bodies. The reflection layer may not be formed at each of the plurality of openings.

The plurality of transparent bodies may be arranged such that each of the plurality of transparent bodies corresponds to a respective corresponding one of the plurality of transparent top electrodes.

The line light source may further comprise a light absorbing member disposed between two adjacent ones of the plurality of transparent bodies.

Each of the plurality of transparent bodies may be formed of one or more material selected from a group consisting of photoresist, poly-methylmethacrylate (PMMA) and poly-dimethylsiloxane (PDMS).

The line light source may further comprise a light absorbing member formed on an inner surface of the reflection layer at a side of the light waveguide unit.

The light emitting layer may have an inorganic electroluminescence structure.

The inorganic electroluminescence structure may be a thin film inorganic electroluminescence structure, which may comprise a lower insulating layer, an inorganic light emitting layer and an upper insulating layer. Such thin film inorganic electroluminescence structure may be interposed between the bottom electrode and the plurality of transparent top electrodes.

The inorganic electroluminescent structure may be a thick dielectric electroluminescence (TDEL) structure, which may comprise a high-k dielectric layer, a lower reflection layer, a lower insulating layer, an inorganic light emitting layer and an upper insulating layer. Such TDEL structure may be interposed between the bottom electrode and the plurality of transparent top electrodes.

The lower reflection layer may be formed of one of a metal and a reflective dielectric material.

The inorganic electroluminescence structure may be a powder inorganic electroluminescence structure, which may comprise a powder inorganic light emitting layer interposed between the bottom electrode and the plurality of transparent top electrodes.

The light emitting layer may have an organic light emitting structure, which may comprise an electron injection layer, an electron transport layer, an organic light emitting layer, a hole transport layer and a hole injection layer. Such organic light emitting structure may be interposed between the bottom electrode and the plurality of transparent top electrodes.

According to another aspect, a line printer head may be provided and arranged to face a photoreceptor of an image forming apparatus. The line printer head may be configured to direct a plurality of light beams onto, and along a line across a main scanning direction of, the photoreceptor to form thereon an electrostatic latent image. The line printer head may comprise: a bottom electrode; a light emitting layer formed above the bottom electrode; a plurality of transparent top electrodes arranged above the light emitting layer and a light waveguide unit formed above the plurality of transparent top electrodes. The plurality of transparent top electrodes may each define a light emitting area. The light waveguide unit may have a plurality of openings. The light waveguide unit may be configured to guide light emitted from the light emitting layer to be from the line light source through one or more of the plurality of openings.

The plurality of the openings may be formed on one of the top surface or on a lateral surface of the light waveguide unit.

The light emitting area may extend along a sub-scanning direction perpendicular to the main scanning direction.

The light waveguide unit may comprise a plurality of transparent bodies and a reflection layer formed on one or more of the top surface and lateral surfaces of each of the plurality of transparent bodies, but not at each of the plurality of openings.

The plurality of transparent bodies may be arranged such that each of the plurality of transparent bodies corresponds to a respective corresponding one of the plurality of transparent top electrodes.

The line printer head may further comprise a light absorbing member formed between two adjacent ones of the plurality of transparent bodies.

Alternatively, the line printer head may further comprise a light absorbing member formed on an inner surface of the reflection layer at a side of the light waveguide unit.

The light emitting layer may have an inorganic electroluminescence structure or an organic electroluminescence structure.

According to yet another aspect, an image forming apparatus may be provided to include a photoreceptor; a line printer head that is disposed to face the photoreceptor and a developing unit supplying toner to the electrostatic latent image formed on the photoreceptor to develop the electrostatic latent image. The line printer may be configured to form an electrostatic latent image on the photoreceptor by irradiating light along a line in a main scanning direction. The light printer head may comprise a bottom electrode, a light emitting layer formed above the bottom electrode, a plurality of transparent top electrodes arranged above the light emitting layer and a light waveguide unit formed above the plurality of transparent top electrodes. Each of the plurality of transparent top electrodes may define a light emitting area. The light waveguide unit may have a plurality of openings, and may be configured to guide light emitted from the light emitting layer to be emitted through one or more of the plurality of openings

### BRIEF DESCRIPTION OF THE DRAWINGS

Various aspects of the present disclosure will become more apparent and more readily appreciated from the following description of the embodiments, taken in conjunction with the accompanying drawings, in which:

FIG. 1 is a perspective view of a line light source according to an embodiment of the present invention;

FIG. 2 is a cross-sectional view of the line light source of FIG. 1 taken along line I-I;

FIG. 3 is a cross-sectional view of the line light source of FIG. 1 taken along line II-II;

FIG. 4 illustrates a light emitting area defined by a bottom electrode and a top electrode in the light source of FIG. 1;

FIGS. 5A through 5E are schematic views illustrating a method of manufacturing the line light source of FIG. 1, according to an embodiment of the present invention;

FIG. 6 illustrates a method of manufacturing a transparent body of a light waveguide unit of a line light source according to another embodiment;

FIG. 7 is a cross-sectional view illustrating the line light source according to another embodiment;

FIG. 8 is a cross-sectional view illustrating the line light source according to yet another embodiment;

FIG. 9 is a cross-sectional view illustrating the line light source according to another embodiment;

FIG. 10 is a cross-sectional view illustrating the line light source according to another embodiment;

FIG. 11 is a cross-sectional view illustrating the line light source according to another embodiment;

FIG. 12 is a perspective view illustrating the line light source according to another embodiment;

FIG. 13 is a cross-sectional view of line light source of FIG. 12 taken along a line III-III;

FIG. 14 is a cross-sectional view of the line light source of FIG. 12 cut along a line IV-IV;

FIG. 15 is a cross-sectional view illustrating the line light source according to another embodiment;

FIG. 16 is a cross-sectional view illustrating the line light source according to another embodiment;

FIG. 17 is a schematic view illustrating an image forming apparatus including a line printer head according to an embodiment; and

FIG. 18 illustrates the line printer head and the photosensitive drum of the image forming apparatus of FIG. 17.

### DETAILED DESCRIPTION OF SEVERAL EMBODIMENTS

Several embodiments will now be described more fully with reference to the accompanying drawings. In the drawings, like reference numerals denote like elements, and the sizes and thicknesses of layers and regions may be exaggerated for clarity. The various embodiments described can have many different forms, and should not be construed as being limited to the embodiments specifically set forth herein. It will also be understood that when a layer is referred to as being “on” another layer or substrate, the layer can be disposed directly on the other layer or substrate, or there could be intervening layers between the layer and the other layers or substrate.

Since line light sources according to the embodiments described herein may be used as line printer heads for image forming apparatus, the line light sources in embodiments described below may be understood as line printer heads.

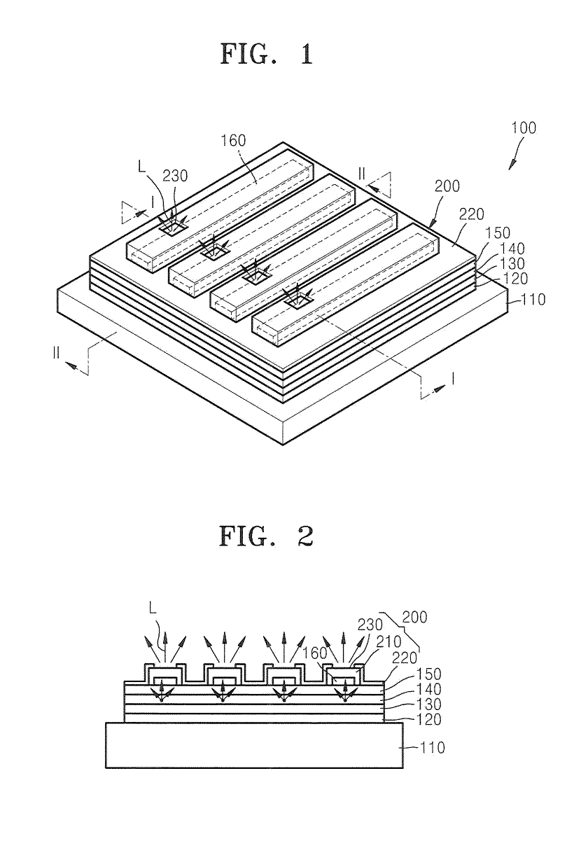

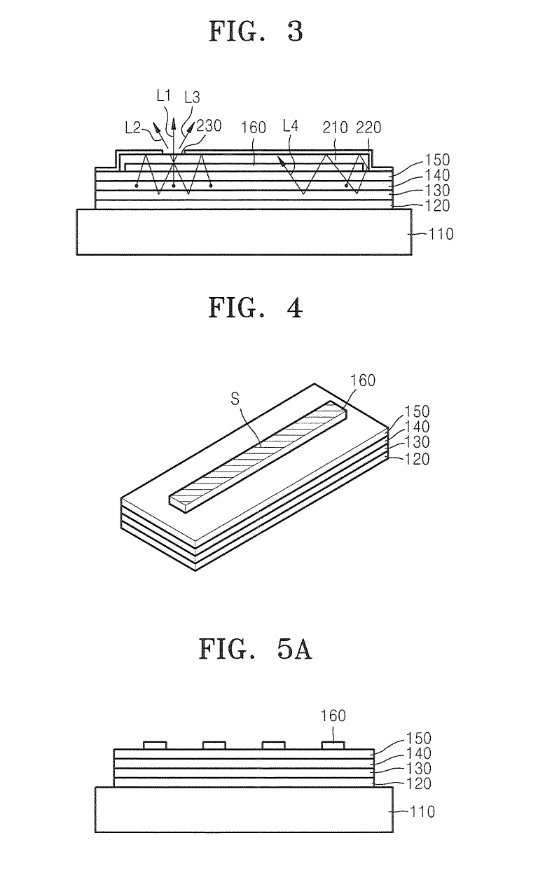

FIG. 1 is a perspective view of a line light source (or a line printer head) 100 according to an embodiment of the present disclosure, FIG. 2 is a cross-sectional view of the line light source 100 taken along line I-I, and FIG. 3 is a cross-sectional view of the line light source 100 taken along line II-II.

Referring to FIGS. 1 through 3, the line light source 100 may include a substrate 110, and a bottom electrode 120, a lower insulating layer 130, an inorganic light emitting layer 140, an upper insulating layer 150, a plurality of top electrodes 160 and a light waveguide unit 200 formed on the substrate 110.

The substrate 110 may be formed of silicon wafer or a transparent glass substrate having SiO₂ as the main component. Also, the substrate 110 may be a plastic substrate such as, e.g., a polymer-based flexible type plastic substrate. The line light source may have a thin film electro-luminescence (TFEL) structure formed of the bottom electrode 120, the lower insulating layer 130, the inorganic light emitting layer 140, the upper insulating layer 150, and the top electrodes 160.

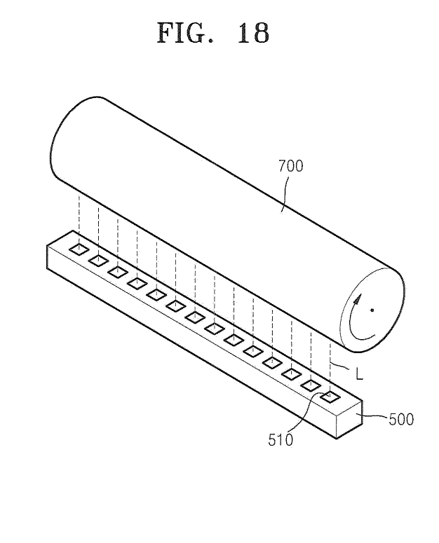

The bottom electrode 120 is a reflective electrode formed of a conductive material having good reflectivity, such as, e.g., aluminum (Al) or silver (Ag). The top electrode is a transmittive electrode formed of a conductive material having good light-transmittivity, such as, e.g., indium tin oxide (ITO). The bottom electrode 120 is formed as a common electrode over the lower area of the lower insulating layer 130 while a plurality of the top electrodes 160 are formed in the upper portion of the line light source 100. The top electrodes 160 may be densely arranged along a line in the main scanning direction. The top electrodes 160 may be formed in the form of, for example, rectangles the longer sides of which extending in the sub-scanning direction. Since the top electrodes 160 define light emitting areas S, the top electrodes 160 are formed to extend in a sub-scanning direction to extend the light emitting areas S (see FIG. 4) while maintaining constant distances between the top electrodes 160 in a main scanning direction. A main scanning direction is the length direction of a photoreceptor as will be described later with reference to FIG. 18, which is the direction along which the top electrodes 160 are arranged in parallel, that is, the direction of the cutting line I-I of FIG. 1. A sub-scanning direction refers to a direction perpendicular to the main scanning direction, that is, the direction along which the top electrodes 160 extend, which is also the direction parallel to the cutting line II-II of FIG. 1. Electrode pads (not shown) are electrically connected to the bottom electrode 120 and the top electrodes 160 so that electric power is supplied from a source external to the line light source 100. A voltage may be applied to the bottom electrode 120 and the select ones of the top electrodes 160 to allow the individual ones of the light emitting areas to independently emit light. As a broad bottom electrode 120 is formed, a wiring resistance is reduced and the light generation efficiency can be increased by increasing the driving frequency of the applied voltage. In this embodiment, the bottom electrode 120 is formed as one common electrode; however, a plurality of bottom electrodes 120 may alternatively be formed, in which case the power may be individually applied.

The lower and upper insulating layers 130 and 150 may be formed of various dielectric materials, such as, for example, Y₂O₃, Ba₂O₃, Al₂O₃, and SiO₂, capable of withstanding high voltages. The inorganic light emitting layer 140 is formed of an inorganic light emitting material generating electroluminescence, and light is emitted by electron excitation of the light emitting material by collision of electrons that are accelerated by the electric field. Examples of the inorganic light emitting material include metal sulfides, such as, e.g., ZnS, SrS, CaS, etc.; alkali-earth potassium sulfides, such as, e.g., CaGa₂S₄, SrGa₂S₄, etc.; transition metals including Mn, Ce, Tb, Eu, Tm, Er,Pr, Pb, etc.; and alkali rare earth metals, for example.

The light waveguide unit 200 guides light emitted from the inorganic light emitting layer 140 to be emitted through an opening 230. The light waveguide unit 200 includes a plurality of transparent bodies 210, a plurality of openings 230, and a plurality of reflection layers 220 formed over the transparent bodies 210, except at the openings 230.

The transparent bodies 210 may be individually formed on the top electrodes 160. As illustrated in FIG. 1, the transparent bodies 210 cover the top electrodes 160. Since the top electrodes 160 are formed in the form of rectangles extending lengthwise in the sub-scanning direction, the transparent bodies 210 may also be formed in the form of rectangles extending in the sub-scanning direction. The transparent bodies 210 may be formed of polymer having good transmittivity. As will be further described later, the transparent bodies 210 may be formed using a photolithography process or an imprinting process using materials, such as, e.g., a photoresist like SU-8, or poly-methylmethacrylate (PMMA) or poly-dimethylsiloxane (PDMS).

The openings 230, from which the light emits, are formed in the upper portion of the light waveguide unit 200. A plurality of the openings 230 are formed to correspond to each of the top electrodes 160, and as will further be described later, the openings 230 are densely arranged along a line in the main scanning direction so that light is emitted line by line. In the current embodiment, the openings 230 are arranged along a single line, but they may also be arranged in two or more lines according to the circumstances of the particular application.

The reflection layer 220 may be formed of a metal having good reflectivity, such as, e.g., aluminum (Al). The reflection layer 220 may be formed on a top surface and/or a lateral surface of the transparent bodies 210 except the openings 230. As illustrated in FIG. 1, the reflection layer 220 is also formed on surfaces of the upper insulating layer 150 where the transparent bodies 210 are not disposed, thereby blocking light emitted through areas other than the top electrodes 160.

When an AC voltage is applied to the bottom electrode 120 and the top electrodes 160, light is generated in an overlapping area of the bottom electrode 120 and the top electrodes 160, wherein the light is emitted in the upward direction through the transparent, top electrodes 160. In other words, light is emitted from the overlapping area of the bottom electrode 120 and the top electrodes 160. FIG. 4 illustrates a light emitting area S defined by the bottom electrode 120 and the top electrode 160. Referring to FIG. 4, the top electrode 160 has a rectangular shape with its longer side extending in the sub-scanning direction, and thus the light emitting area S is formed as a long rectangle.

The operation of the line light source 100 will be described with reference to FIG. 3.

When a common voltage is applied to the bottom electrode 120 and a voltage is respectively applied to select ones of the plurality of the top electrodes 160, an electric field is applied between the bottom electrode 120 and the selected top electrodes 160. Then, electrons in an inorganic light emitting material of the inorganic light emitting layer 140 are excited by collision of with electrons accelerated by the electric field, and then stabilized to emit light. The light emitted from the inorganic light emitting layer 140 may be immediately directed to the top electrodes 160, or may be reflected off the bottom electrode 120 and then directed to the top electrodes 160. Thus, the light generated in the inorganic light emitting layer 140 is emitted through the top electrodes 160, and thus as many light emitting areas (S in FIG. 4) as the number of the top electrodes 160 are formed.

The light waveguide unit 200 guides the light emitted from the light emitting areas S to exit through the openings 230. A portion L1 of the light generated in the inorganic light emitting layer 140 is directly emitted through the openings 230, and other portions L2 and L3 are reflected between the bottom electrode 120 and the reflection layer 220 and then emitted. Still another portion L4 of the light generated in the inorganic light emitting layer 140 may repeatedly reflected between the bottom electrode 120 and the reflection layer 220 until it disappears; however, the amount of such disappearing portion L4 may be very small. Accordingly, most of the light generated in the inorganic light emitting layer 140 by the light waveguide unit 200 is emitted through the openings 230. The surface area of the openings 230 may be chosen independently of the surface area of the light emitting areas S, and is only limited by the distances between the top electrodes 160 in a main scanning direction. Accordingly, even when an inorganic electroluminescence structure with low output power is included as in the current embodiment, a large amount of light can be provided by enlarging the light emitting areas S. Thus, the driving power source (voltage and current) can be reduced, and/or the lifetime of the line light source 100 can be increased.

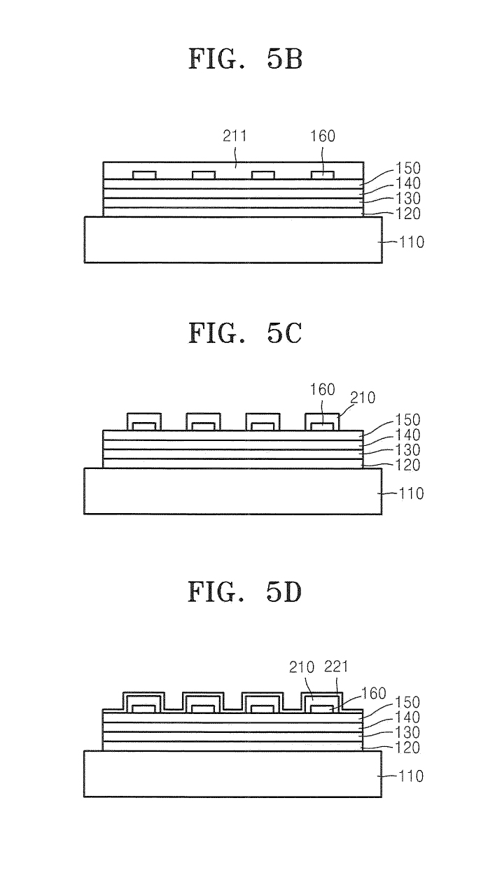

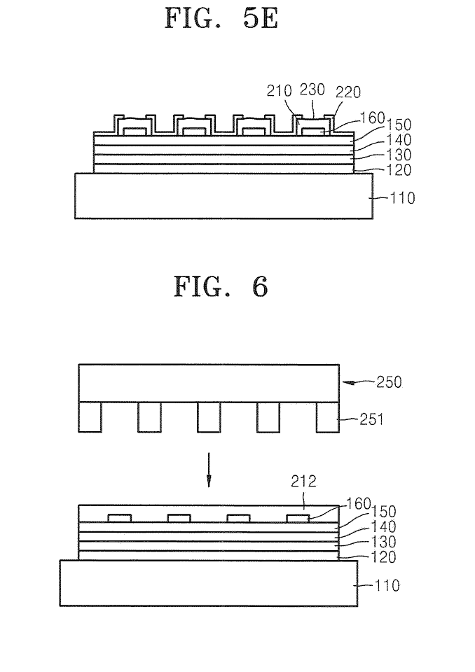

FIGS. 5A through 5E are schematic views for explaining a method of manufacturing the line light source 100 of FIG. 1, according to an embodiment of the present disclosure.

Referring to FIG. 5A, first, a thin film inorganic electroluminescence (TFEL) structure formed of a bottom electrode 120, a lower insulating layer 130, an inorganic light emitting layer 140, an upper insulating layer 150, and top electrodes 160 is formed. Next, as illustrated in FIG. 5B, the tipper insulating layer 150 and the top electrodes 160 are covered by a photoresist 211 having good light transmittivity, such as, e.g., SU-8. Next, as illustrated in FIG. 5C, the photoresist is removed from areas except around the top electrodes 160 using a photolithography process to form transparent bodies 210 of the light waveguide unit 200. Next, referring to FIG. 5D, a metal layer 221 is formed by depositing a metal, such as, e.g., Al, having good reflectivity, and, as shown in FIG. 5E, a portion of the metal layer 221 is removed using a photolithography process to form a reflection layer 220 with openings 230. Thus a line light source is manufactured.

The manufacturing process of the line light source 100 described with reference to FIGS. 5A through 5E is just an example, and other embodiments using different processes is also possible. For example, in the operation of FIG. 5C, the reflection layer 220 having openings 230 illustrated in FIG. 5E can alternatively be formed directly using a shadow mask method.

FIG. 6 illustrates another example of a method of manufacturing a transparent body. First, a master 250 having a reverse form with respect to patterns of the transparent body is formed. The master 250 may be formed using a photolithography method. Meanwhile, a polymer 212 having good light transmittivity, such as, e.g., PDMS or PMMS, is coated over the thin film inorganic electroluminescence structure formed of the bottom electrode 120, the lower insulating layer 130, the inorganic light emitting layer 140, the upper insulating layer 150 and the top electrodes 160. By pressurizing the master 250 over the coated polymer 212, the polymer 212 may be patterned in the shape of the transparent bodies 210 illustrated in FIG. 5C.

FIG. 7 is a cross-sectional view illustrating a line light source 100-1 according to another embodiment.

The line light source 100-1 of FIG. 7 is substantially the same as the line light source of the previous embodiment described with reference to FIGS. 1 through 4. Accordingly, like reference numerals denote like elements, and the same descriptions as in the previous embodiment will be simplified or omitted.

Referring to FIG. 7, the line light source 100-1 includes a bottom electrode 120, a high-k dielectric layer 135, a lower reflection layer 133, a lower insulating layer 131, an inorganic light emitting layer 140, an upper insulating layer 150, a plurality of top electrodes 160, and a light waveguide unit 200 on a substrate 110.

The bottom electrode 120, the high-k dielectric layer 135, the lower reflection layer 133, the lower insulating layer 131, the inorganic light emitting layer 140, the upper insulating layer 150 and the plurality of the top electrodes 160 together form a thick dielectric electroluminescence (TDEL) structure. The lower reflection layer 133 may be formed of a metal having good reflectivity or be a highly reflective dielectric layer. Light emitted from the inorganic light emitting layer 140 may be reflected between the lower reflection layer 133 and the reflection layer 220 of the light waveguide unit 200 and is emitted through the opening 230. Due to the high-k dielectric layer 135, a large electric field may be applied between the bottom electrode 120 and the top electrodes 160, and thus the light emitting efficiency and/or the lifetime of the line light source can be increased. The TDEL structure is well known in the art, and thus the detailed description of each layer of the TDEL structure will be omitted.

FIG. 8 is a cross-sectional view illustrating a line light source 100-2 according to another embodiment.

The line light source 100-2 of FIG. 8 is substantially the same as the line light source of the previous embodiment described with reference to FIGS. 1 through 4. Accordingly, like reference numerals denote like elements, and repeated descriptions in both embodiments will be simplified or omitted.

Referring to FIG. 8, the line light source 100-2 includes a bottom electrode 120, a powder inorganic light emitting layer 141, an upper insulating layer 150, a plurality of top electrodes 160, and a light waveguide unit 200 on a substrate 110.

The bottom electrode 120, the powder inorganic light emitting layer 141, the upper insulating layer 150, and the plurality of the top electrodes 160 form a powder electro-luminescence structure. The powder inorganic light emitting layer 141 may be formed of a mixture of a fluorescent substance material and a dielectric binder mixed at a predetermined ratio, and an additional insulating layer may be omitted due to the insulating characteristics of the powder inorganic light emitting layer 141. In the current embodiment, the upper insulating layer 150 is interposed between the plurality of the top electrodes 160 and the powder inorganic light emitting layer 141; however, the upper insulating layer 150 may be omitted, and only a lower insulating layer may be interposed between the bottom electrode 120 and the powder inorganic light emitting layer 141. The powder electroluminescence structure requires no additional insulating layer, that is, a dielectric layer, and thus can be manufactured using a simplified manufacturing process, and the decrease in brightness due to the dielectric layer can be reduced. Since the powder electroluminescence structure is well known in the art, detailed description about each layer will be omitted.

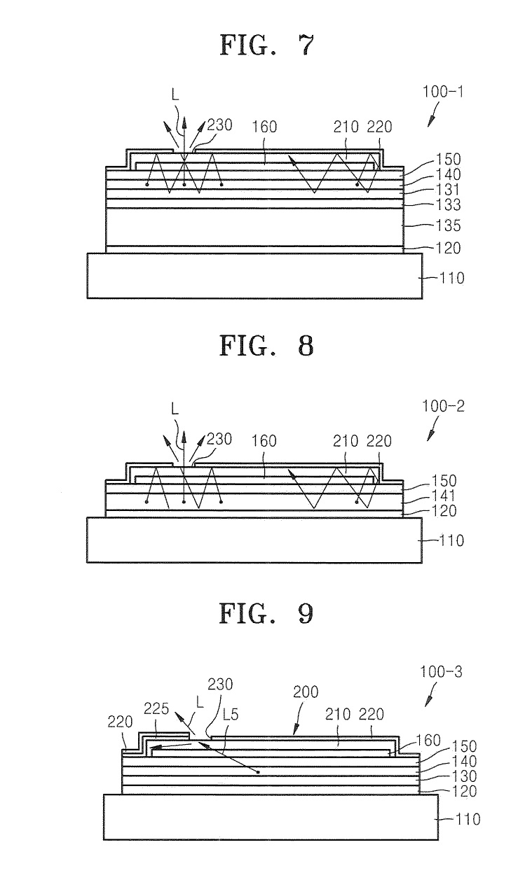

FIG. 9 is a cross-sectional view illustrating a line light source 100-3 according to another embodiment of the present general inventive concept.

The line light source 100-3 of FIG. 9 is substantially the same as the line light source of the previous embodiment described with reference to FIGS. 1 through 4, except that a light absorbing member 225 is further included. Accordingly, like reference numerals denote like elements, and repeated descriptions in both embodiments will be simplified or omitted.

Referring to FIG. 9, the line light source 100-3 includes a bottom electrode 120, a lower insulating layer 130, an inorganic light emitting layer 140, an upper insulating layer 150, a plurality of top electrodes 160, and a light waveguide unit 200, and a light absorbing member 225, on a substrate 110.

The light absorbing member 225 absorbs light, and is formed on the inner surface of a reflection layer 220 at a side of the light waveguide unit 200. The light absorbing member 225 may be a coating agent including coloring matter composition capable of absorbing light, and the scope of the current embodiment is not limited to any specific material employed for the light absorbing member 225.

When power is applied to the bottom electrode 120 and the top electrodes 160, light is emitted from the inorganic light emitting layer 140. While most of the emitted light is exits through the openings 230, a portion L5 of the light may be repeatedly totally internally reflected or normally reflected between the bottom electrode 120 and the reflection layer 220, and confined in the structure. Thus, a portion of the confined light L5 may leak through areas other than the intended opening 230, and the light leaked out in this manner may cause ghost spots on a photoreceptor. The light absorbing member 225 absorbs this light confined between the bottom electrode 120 and the reflection layer 220.

FIG. 10 is a cross-sectional view illustrating a line light source 100-4 according to another embodiment.

The line light source 100-4 of FIG. 10 is substantially the same as the line light source of the previous embodiment described with reference to FIGS. 1 through 4, except that a light absorbing member 226 is further included. Accordingly, like reference numerals denote like elements, and the same descriptions as in the previous embodiment will be simplified or omitted.

Referring to FIG. 10, the line light source 100-4 includes a bottom electrode 120, a lower insulating layer 130, an inorganic light emitting layer 140, an upper insulating layer 150, a plurality of top electrodes 160, and a light waveguide unit 200 and a light absorbing member 226, on a substrate 110.

The light absorbing member 226 absorbs light, and may be formed between transparent bodies 210 which are arranged to be spaced apart at predetermined distances from one another. That is, the light absorbing member 226 may be interposed between the upper insulating layer 150 and the reflection layer 220 which are disposed between the transparent bodies 210. The light absorbing member 226 may be a coating agent including a coloring matter composition capable of absorbing light, however the material of the light absorbing member 226 is not limited to the above example.

When power is supplied to the bottom electrode 120 and the top electrodes 160, light is emitted from the inorganic light emitting layer 140. While most of the emitted light L is emitted through the openings 230, a portion of the light may be repeatedly totally internally reflected or normally reflected between the bottom electrode 120 and the reflection layer 220. The portion of the light repeatedly reflected may not be emitted to the openings 230 at the top electrodes 160, to which a voltage is applied, but may exit through other adjacent openings 230, thereby causing crosstalk. The light absorbing member 226 absorbs the light emitted that may otherwise exit through these adjacent openings 230.

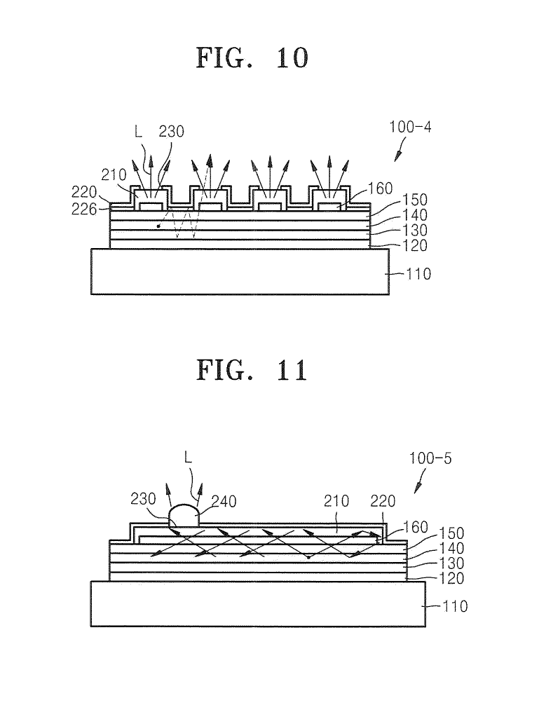

FIG. 11 is a cross-sectional view illustrating a line light source 100-5 according to another embodiment.

The line light source 100-5 of FIG. 11 is substantially the same as the line light source of the previous embodiment described with reference to FIGS. 1 through 4, except that a micro lens 240 is further included. Accordingly, like reference numerals denote like elements, and the same descriptions will be simplified or omitted.

Referring to FIG. 11, the line light source 100-5 includes a bottom electrode 120, a lower insulating layer 130, an inorganic light emitting layer 140, an upper insulating layer 150, a plurality of top electrodes 160, a light waveguide unit 200 and a micro lens 240, on a substrate 110.

The micro lens 240 collimates light L that is emitted, and may be formed at each of the openings 230 disposed in the upper portion of the light waveguide unit 200. Thus the emitted light having a broad radiation angle can be collimated using the micro lens 240, thereby increasing the light efficiency. Also, by selecting the micro lens 240 to have an appropriate power, a spot size can be adjusted such that exposure spots formed on a photoreceptor are not separated apart from, but substantially adjacent or in closer proximity to, one another.

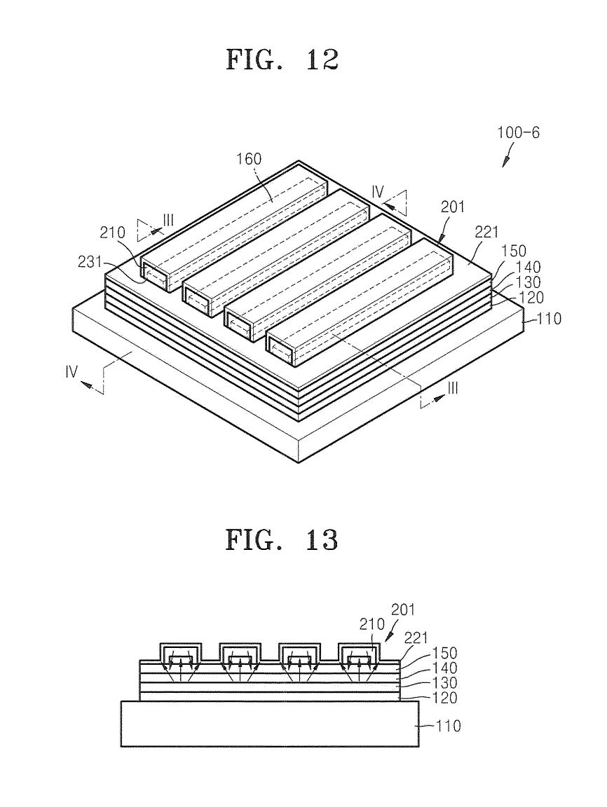

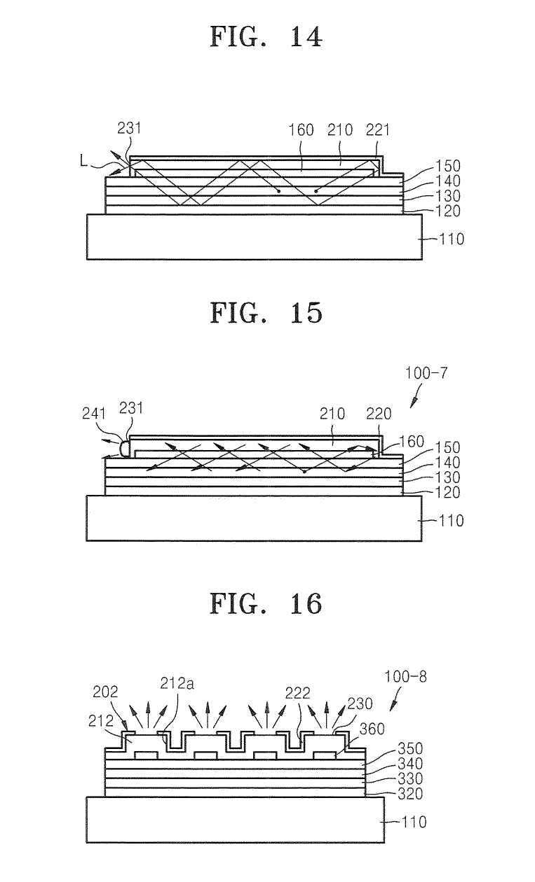

FIG. 12 is a perspective view illustrating a line light source 100-6 according to another embodiment. FIG. 13 is a cross-sectional view of the line light source 100-6 of FIG. 12 taken along line III-III. FIG. 14 is a cross-sectional view of the line light source 100-6 of FIG. 12 taken along line IV-IV.

The line light source 100-6 of FIG. 12 is substantially the same as the line light source of the previous embodiment described with reference to FIGS. 1 through 4, except that openings 231 in place of the openings 230 are formed in the light waveguide units 201. Accordingly, like reference numerals denote like elements, and the same descriptions in both embodiments will be simplified or omitted.

Referring to FIGS. 12 through 14, the line light source 100-6 includes a bottom electrode 120, a lower insulating layer 130, an inorganic light emitting layer 140, an upper insulating layer 150, a plurality of top electrodes 160 and a light waveguide unit 201 on a substrate 110.

The light waveguide unit 201 guides light emitted in the inorganic light emitting layer 140 to be emitted through the opening 231 and includes a plurality of transparent bodies 210, and a reflection layer 221 formed over top and/or lateral surfaces of the transparent bodies 210, except at the openings 231.

The line light source 100-6 is a side emission type line light source in which the opening 231, through which the light exits, is formed at a side of the light waveguide unit 201. A plurality of the openings 231 are formed to correspond to each of the plurality of the tope electrodes 160, and may be densely formed along a line in the main scanning direction so as to expose a line of the photoreceptor at a time, as will be further described later. That is, the openings 231 are arranged in a line when seen along the side of the light waveguide unit 201. The reflection layer 221 may be formed on the top and/or lateral surfaces of the transparent body 210, except at the opening 231. As illustrated in FIG. 13, the reflection layer 221 is also formed on the upper insulating layer 150 where the transparent body 210 is not disposed, and thus may block light emitted through areas other than the top electrodes 160.

The current embodiment includes a thin film inorganic electroluminescence structure formed of the bottom electrode 120, the lower insulating layer 130, the inorganic light emitting layer 140, the upper insulating layer 150, and the plurality of the top electrodes 160, the scope of which embodiment is however not so limited, and may alternatively employ a TDEL structure or a powder electro-luminescence structure previously described. Accordingly, the specific electroluminescence structure does not limit the scope of the current embodiment.

FIG. 15 is a cross-sectional view illustrating a line light source 100-7 according to another embodiment.

The line light source 100-7 of FIG. 15 is substantially the same as the line light source of the previous embodiment described with reference to FIGS. 12 through 14, except that a micro lens 241 is further formed. Accordingly, like reference numerals denote like elements, and the same descriptions as in the previous embodiment will be simplified or omitted.

Referring to FIG. 15, the line light source 100-7 includes a bottom electrode 120, a lower insulating layer 130, an inorganic light emitting layer 140, an upper insulating layer 150, a plurality of top electrodes 160, a light waveguide unit 201 and a micro lens 241, on a substrate 110.

The micro lens 241 collimates light L being emitted, and may be formed at each of the openings 230 disposed in the upper portion of the light waveguide unit 201. The emission light having a broad radiation angle can be collimated using the micro lens 241, thereby increasing the light efficiency. Also, by selecting appropriate power of the micro lens 241, a spot size can be adjusted such that exposure spots formed on a photoreceptor arc not separated apart from each other but in the desired proximity to one another.

FIG. 16 is a cross-sectional view illustrating a line light source 100-8 according to another embodiment.

Referring to FIG. 16, the line light source 100-8 includes a bottom electrode 320, an electron injection layer 330, an organic light emitting layer 340, a hole injection layer 350, a plurality of top electrodes 360 and a light waveguide unit 202, on a substrate 310. The line light source 100-8 is substantially the same as the line light source of the above-described embodiment described with reference to FIGS. 1 through 4, except that an organic electroluminescence structure is used. Accordingly, like reference numerals denote like elements, and the same descriptions as in the above-described embodiment will be simplified or omitted.

The line light source 100-8 has an organic electroluminescence (OEL) structure including a bottom electrode 320, an electron injection layer 330, an organic light emitting layer 340, a hole injection layer 350 and a plurality of top electrodes 360. An electron transport layer (not shown) may be further interposed between the electron injection layer 330 and the organic light emitting layer 340, and a hole transport layer (not shown) may be further interposed between the organic light emitting layer 340 and the hole transport layer 350. The organic light emitting layer 340 may be formed of a material, such as, e.g., copper phthalocyanine (CuPc), N,N′-Di(naphthalene-1-yl)-N,N′-diphenyl-ben zidine (NPB), tris-8-hydroxyquinoline aluminum)(Alq3), and the like.

When power is applied to the bottom electrode 320 and the top electrodes 360, holes injected from the top electrodes 360, which are positive electrodes, pass through the hole injection layer 350 and are moved to the organic light emitting layer 340, and electrons are transported from the bottom electrodes 320, which are negative electrodes, pass through the electron injection layer 330, and are injected to the organic light emitting layer 340. The electrons and the holes are combined again in the organic light emitting layer 340 causing light emission.

A light waveguide unit 202 guides the light generated in the organic light emitting layer 340 to exit through the opening 230. The light waveguide unit 202 includes a transparent body 212 and a reflection layer 222 formed on top and/or lateral surfaces of the transparent body 212, except at the opening 230. The transparent body 212 is coated to cover the entire region of the hole injection layer 350, and functions as a cover protection layer that chemically stabilizes the electron injection layer 330, the organic light emitting layer 340, and the hole injection layer 350. Meanwhile, a groove 212a may be formed in the transparent body 212 to a predetermined depth such that light emitted from each of the top electrodes 360 is not emitted through other adjacent openings 230.

In the embodiment shown in FIG. 16, light is emitted above the light waveguide unit 202, but various other alternative embodiments are possible. For example, the line light source 100-8 may have a side emission structure as described with reference to the previous embodiments. Also, the line light source 100-8 may further include various light absorbing member in such manner also previously described.

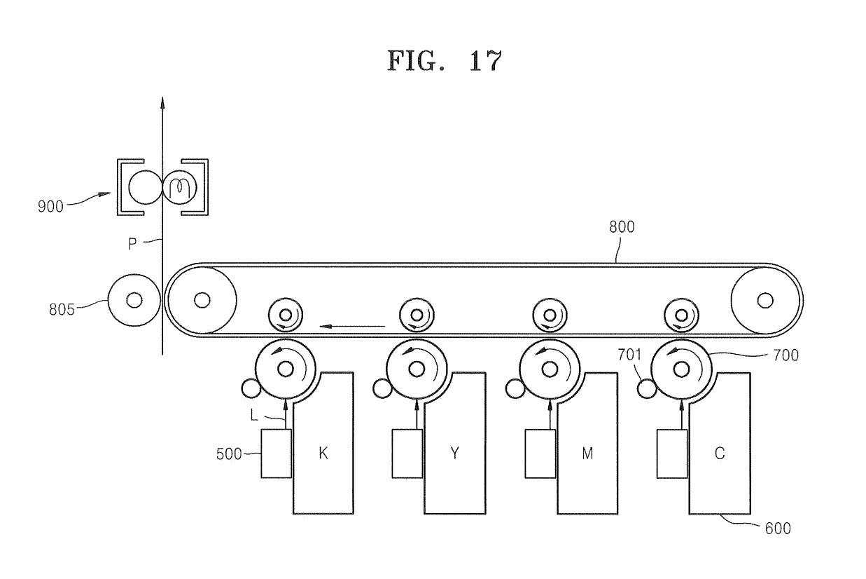

FIG. 17 is a schematic view illustrating an image forming apparatus including a line light source (line printer head) according to an embodiment of the present disclosure, and FIG. 18 illustrates the line printer head and the photosensitive drum of the image forming apparatus of FIG. 17.

Referring to FIG. 17, the image forming apparatus may include a plurality of line printer heads 500, a plurality of developing units 600, a plurality of photosensitive drums 700, a plurality of charging rollers 701, an intermediate transfer belt 800, a transfer roller 805, and a fixing unit 900.

The line printer head 500 may emit a linear light L, which is modulated according to image information, to the photosensitive drums 700, and may be the line light source according to any of the above-described various embodiments. The photosensitive drum 700 is an example of a photoreceptor, and includes a photosensitive layer of a predetermined thickness the an outer circumferential surface of a cylinder metal pipe. The outer circumferential surface of the photosensitive drum 700 is a surface whereon the light L scanned from the line printer head 500 forms a latent image. A belt type photosensitive body may alternatively be used as a photoreceptor instead of the drum type shown in FIG. 17. The charging roller 701 is rotated while contacting the photosensitive drum 700 and charges the surface of the photosensitive drum 700 to a uniform electric potential. A charging bias voltage Vc is applied to the charging roller 701. A corona charger (not shown) may alternatively be used instead of the charging roller 701. Toner is contained in the developing unit 600. The toner is transported to the photosensitive drum 700 in response to a developing bias voltage applied between the developing unit 600 and the photosensitive drum 700, and is used to develop the electrostatic latent image that had formed on the photosensitive drum 700 into a visible toner image. The toner image formed on the photosensitive drum 700 is transferred to the intermediate transfer belt 800. The toner image is in turn transferred to a paper P that is transported between the transfer roller 805 and the intermediate transfer belt 800 by a transfer bias voltage applied to the transfer roller 805. The toner image transferred to the paper P is fixed on the paper P by heat and pressure by the fixing unit 900, thereby completing formation of an image.

In order to print a color image, each of the line printer heads 500, each of the developing units 600, and each of the photosensitive drums 700 corresponding to one color. The line printer head 500 scans four light beams to the four photosensitive drums 700. In the four photosensitive drums 700, electrostatic latent images corresponding to image information of black (K), magenta (M), yellow (Y), and cyan (C) are formed. The four developing units 600 supply toner of black (K), magenta (M), yellow (Y), and cyan (C) colors to the photosensitive drums 700 to form toner images of black (K), magenta (M), yellow (Y), and cyan (C). The toner images of black (K), magenta (M), yellow (Y), and cyan (C) are transferred to the intermediate transfer belt 800 overlapping one another, and in turn transferred to the paper P.

In the above-described image forming apparatus, the line printer heads 500, the developing units 600, and the photosensitive drums 700 are arranged to respectively correspond to each of the colors, but the present embodiment is not limited thereto. In the case of printing a monochromic image, one line printer head, one developing unit, and one photosensitive drum may be needed.

The line light source described with reference to FIGS. 1 through 16 may be used as the line printer head 500. The line printer head 500 emits light L through openings 510 arranged in a line, and the emitted light L forms spots on the photosensitive drum 700 in a line in a main scanning direction. The line printer head 500 transmits light to the photosensitive drum 700 line by line, and as the photosensitive drum 700 is rotated, two-dimensional electrostatic latent images are formed on the outer circumferential surface of the photosensitive drum 700. A light transmission member (not shown) transmitting light L such as a rod lens array may be arranged between the line printer head 500 and the photosensitive drum 700.

According to the embodiments described herein, the amount of light scanned to the photosensitive drum 700 can be greatly increased by increasing the light emitting surface area (S in FIG. 4), and thus the photosensitive drum 700 can be exposed to light within a short time. In this case, the linear speed of the photosensitive drum 700 can be increased, thereby increasing the printing speed.

While the line light source, the line printer head, and the image forming apparatus of the present disclosure have been particularly shown and described with reference to specific embodiments thereof, it will be understood by those of ordinary skill in the art that various changes in form and details may be made therein without departing from the spirit and scope of the present disclosure as defined by the following claims.

What is claimed is:

1. A line light source, comprising:
a bottom electrode;
a light emitting layer formed above the bottom electrode;
a plurality of transparent top electrodes arranged above the light emitting layer, the plurality of transparent top electrodes each defining a light emitting area; and
a light waveguide unit formed above the plurality of transparent top electrodes, the light waveguide unit having a plurality of openings, the light waveguide unit being configured to guide light emitted from the light emitting layer to be emitted from the line light source through one or more of the plurality of openings.

2. The line light source of claim 1, wherein the plurality of openings each corresponds to the light emitting area of a respective corresponding one of the plurality of transparent top electrodes.

3. The line light source of claim 1, wherein the plurality of the openings are arranged along a single line.

4. The line light source of claim 1, wherein the plurality of the openings are formed on one of a top surface and a lateral surface of the light waveguide unit.

5. The line light source of claim 2, wherein each of the plurality of openings has a size smaller than the surface area of the light emitting area of the corresponding one of the plurality of transparent top electrodes.

6. The line light source of claim 5, wherein the light emitting area extends along a sub-scanning direction.

7. The line light source of claim of claim 1, further comprising a micro lens disposed at each of the openings.

8. The line light source of claim 1, wherein the light waveguide unit comprises:
a plurality of transparent bodies; and
a reflection layer formed on one or more of a top surface and lateral surfaces of each of the plurality of transparent bodies, the reflection layer being absent at each of the plurality of openings.

9. The line light source of claim 8, wherein the plurality of transparent bodies are arranged such that each of the plurality of transparent bodies corresponds to a respective corresponding one of the plurality of transparent top electrodes.

10. The line light source of claim 9, further comprising a light absorbing member disposed between two adjacent ones of the plurality of transparent bodies.

11. The line light source of claim 8, wherein each of the plurality of transparent bodies is formed of one or more material selected from a group consisting of photoresist, poly-methylmethacrylate (PMMA) and poly-dimethylsiloxane (PDMS).

12. The line light source of claim 8, further comprising a light absorbing member formed on an inner surface of the reflection layer at a side of the light waveguide unit.

13. The line light source of claim 1, wherein the light emitting layer has an inorganic electroluminescence structure.

14. The line light source of claim 13, wherein the inorganic electroluminescence structure is a thin film inorganic electroluminescence structure comprising a lower insulating layer, an inorganic light emitting layer and an upper insulating layer, the thin film inorganic electroluminescence structure being interposed between the bottom electrode and the plurality of transparent top electrodes.

15. The line light source of claim 14, wherein the inorganic electroluminescent structure is a thick dielectric electroluminescence (TDEL) structure comprising a high-k dielectric layer, a lower reflection layer, a lower insulating layer, an inorganic light emitting layer and an upper insulating layer, the TDEL structure being interposed between the bottom electrode and the plurality of transparent top electrodes.

16. The line light source of claim 15, wherein the lower reflection layer is formed of one of a metal and a reflective dielectric material.

17. The line light source of claim 13, wherein the inorganic electroluminescence structure is a powder inorganic electroluminescence structure comprising a powder inorganic light emitting layer interposed between the bottom electrode and the plurality of transparent top electrodes.

18. The line light source of claim 1, wherein the light emitting layer has an organic light emitting structure comprising an electron injection layer, an electron transport layer, an organic light emitting layer, a hole transport layer and a hole injection layer, the organic light emitting structure being interposed between the bottom electrode and the plurality of transparent top electrodes.

19. A line printer head arranged to face a photoreceptor of an image forming apparatus, the line printer head being configured to direct a plurality of light beams onto, and along a line across a main scanning direction of, the photoreceptor to form thereon an electrostatic latent image, the line printer head comprising:
a bottom electrode;
a light emitting layer formed above the bottom electrode;
a plurality of transparent top electrodes arranged above the light emitting layer, the plurality of transparent top electrodes each defining a light emitting area; and
a light waveguide unit formed above the plurality of transparent top electrodes, the light waveguide unit having a plurality of openings, the light waveguide unit being configured to guide light emitted from the light emitting layer to be emitted from the line light source through one or more of the plurality of openings.

20. The line printer head of claim 19, wherein the plurality of the openings are formed on one of a top surface and a lateral surface of the light waveguide unit.

21. The line printer head of claim 19, wherein the light emitting area extends along a sub-scanning direction substantially perpendicular to the main scanning direction.

22. The line printer head of claim 19, further comprising a micro lens disposed at each of the plurality of openings.

23. The line printer head of claim 19, wherein the light waveguide unit comprises:
a plurality of transparent bodies; and
a reflection layer formed on one or more of a top surface and lateral surfaces of each of the plurality of transparent bodies, the reflection layer being absent at each of the plurality of openings.

24. The line printer head of claim 23, wherein the plurality of transparent bodies are arranged such that each of the plurality of transparent bodies corresponds to a respective corresponding one of the plurality of transparent top electrodes.

25. The line printer head of claim 24, further comprising a light absorbing member formed between two adjacent ones of the plurality of transparent bodies.

26. The line printer head of claim 23, further comprising a light absorbing member formed on an inner surface of the reflection layer at a side of the light waveguide unit.

27. The line printer head of claim 19, wherein the light emitting layer has one of an inorganic electroluminescence structure and an organic electroluminescence structure.

28. An image forming apparatus, comprising:
a photoreceptor;
a line printer head that is disposed to face the photoreceptor, the line printer being configured to form an electrostatic latent image on the photoreceptor by irradiating light along a line in a main scanning direction, wherein the light printer head comprises a bottom electrode; a light emitting layer formed above the bottom electrode; a plurality of transparent top electrodes arranged above the light emitting layer and a light waveguide unit formed above the plurality of transparent top electrodes, each of the plurality of transparent top electrodes defining a light emitting area, the light waveguide unit having a plurality of openings, the light waveguide unit being configured to guide light emitted from the light emitting layer to be emitted through one or more of the plurality of openings; and
a developing unit supplying toner to the electrostatic latent image formed on the photoreceptor to develop the electrostatic latent image.
